(19) United States
(12) Patent Application Publication
(10) Pub. No.: US 2004/0137310 A1
(43) Pub. Date: Jul. 15, 2004

(54) Oxygen reduction electrode

(76) Inventor: Yohannes Kiros, Solna (SE)

Correspondence Address: YOUNG & THOMPSON, 745 SOUTH 23RD STREET 2ND FLOOR, ARLINGTON, VA, 22202

(21) Appl. No.: 10/471,763

(22) PCT Filed: Mar. 18, 2002
(86) PCT No.: PCT/SE02/00507

(30) Foreign Application Priority Data
Mar. 16, 2001 (SE) 0100927-3

(51) Int. Cl. H01M 4/94; H01M 4/96; H01M 4/88

(52) U.S. Cl. 429/42; 429/44; 502/101

(57) ABSTRACT

The invention refers to an oxygen reduction electrode comprising at least three layers: a current collector; a diffusion layer comprising at least PTFE; and a catalytical active layer, comprising at least a mixture of perovskites and pyrolysed macrocycles. In this way, oxygen may be utilised from air without an initial removal of carbon dioxide. Moreover, the invention refers to methods for preparing the electrode, as well as fuel cells and other products wherein the electrode can be used.

### TECHNICAL FIELD

The invention is related to porous gas diffusion electrodes for applications in alkaline fuel cells (AFC), in direct methanol fuel cells (DMFC), in metal-air batteries, such as metal hydride-air, zinc-air, aluminium-air, iron-air or in any combination of secondary alkaline cells. However, the invention is not limited to alkaline based electrolytes but can also find application in acidic, carbonate and solid polymer electrolyte systems.

### TECHNICAL BACKGROUND

A fuel cell is an electrochemical cell, which continuously can convert the chemical energy of a fuel and an oxidant to electrical energy by a process involving an essentially invariant electrode-electrolyte system.

When an oxygen reduction electrode is used in the fuel cell, the electrode is normally constructed of three layers: a current collector, a diffusion layer, for receiving the incoming oxygen-containing gas, and letting it come in contact with the third layer, the active layer. The active layer faces the electrolyte and comprises catalytic compounds, allowing the electrochemical reaction to occur.

The state-of-the-art porous electrodes for oxygen reduction reaction in alkaline electrolyte have been limited to pure oxygen or prior purification of air to the electrodes. The small concentration of carbon dioxide usually between 340-380 ppm reacts with the hydroxide ion, reduces the concentration and interferes with the electrode kinetics of the porous electrode. The enrichment of the electrolyte by carbonates increases the viscosity of the electrolyte and the limiting current, which is inversely proportional to viscosity, declines significantly leading to poor utilization of the electrode over a longer period. Furthermore, precipitation of the carbonates in the porous structures of the electrode changes the hydrophobic properties and leads to a faster drowning or flooding of the electrode. Specific requirements are thus set to total removal of carbon dioxide from the air, especially for the cathode to find applications in alkaline fuel cells, metal-air batteries or secondary cells. Application in stationary or tractionary systems, small battery units, thus require high investment costs for purification, such as in electrodialysis cell, wet scrubbing by means of alkalis, in primary, secondary or tertiary amines, in membranes, and adsorption in solid materials.

Various attempts have been made in the field of oxygen reduction electrodes in order to prepare electrodes showing desired properties. A number of materials and combinations of materials have been tested, specifically for the catalytic layer of the electrode (Kiros et al., J. Power Sources, 36 (1991), page 547-555; Kiros et al., J. Power Sources, 45 (1993), page 219-227; Kiros et al., Int. J. Hydrogen Energy 24, (1999), 549-564; Kiros, J. Electrochemical Society 143:7, (1996), 2152-2157).

For instance, EP-A-0047080 discloses an oxygen reducing cathode used in a method for electrolysing an aqueous solution of an alkali metal chloride (in contrary to the invention which relates to the use of double-layered gas diffusion electrodes in fuel cells), wherein both the anode and the cathode rooms are separated by a cation ex-change membrane and the catalysts are bonded with the PTFE in single layers and may consist of a noble metal, an alloy of noble metals, a spinel compound, a perovskite type ionic crystal or a transition metal macrocyclic complex. JP-A-7220734 discloses a method for manufacturing of a gas diffusion electrode comprising steps of hot pressing and rolling to obtain an electrode of polytetrafluorethylene, carbon black and a surface active agent to be used in a solid state macromolecule electrolyte type fuel cell. EP-A-0292431 discloses a gas diffusion electrode, which may include a hydrophobic layer and hydrophilic halogenated polymer binder with or without gas supplying layer and find application in fuel cells and metal-air batteries. The active layer is made up of particulate carbon and a catalyst. The examples disclose the use of the heated residue of the macrocycle CoTMPP (cobalt tetra-methoxyphenyl porphyrin) prepared by direct milling and combination with carbon as only catalyst in experiments wherein a mixture of electrolytes is used and the incoming air to the electrode is stated to be essentially free of CO₂.

Perovskites, having pore sizes above 50 Å, have been used in fuel cells. Like the common catalyst Pt, the reaction proceeds by the overall two pathways in the presence of carbon, giving them good catalytic properties. The advantage with perovskites is that they block the passage of CO₂-molecules. For example, if 300 ppm CO₂ is let in to an electrode equipped with perovskites, only 50 ppm gets through. Moreover, porphyrin compounds have shown a high activity at oxygen reduction. Carbon dioxide passes through, but peroxides are formed, which attacks the catalyst. Furthermore, Co—Pt alloys have been used. Co has properties much like porphyrin described above, and Pt displays catalyst properties similar to perovskites. This alloy is functional for approximately 800 h in air. In addition, a mixture of Co and porphyrin has also been used. Hereby, Co has shown to leak to the electrolyte.

To summarise, a problem with the known electrodes is that they show a short life-span, due to enrichment of, in particular, carbonates when carbon dioxide is present in the incoming air. Accordingly, the carbon dioxide in the air to be used must be removed, or pure oxygen used. This of course complicates the process and makes it more expensive. None of the prior art documents above addresses this problem, and only discloses the use of oxygen free from carbon dioxide. Thus, there is a need for an oxygen reduction electrode, for which air, containing CO₂, can be used without severely reducing the life span for the electrode.

Accordingly, it is a main purpose of the present invention to prepare porous electrodes and active catalyst materials, which are not influenced by the presence or amount of carbon dioxide, incoming with air to the cathode.

### SUMMARY OF THE INVENTION

Surprisingly, it has now been found, that a porous oxygen reduction electrode for alkaline electrolytes comprising at least three layers:

(a) a supportive and conductive current collector;

(b) a diffusion layer, comprising at least PTFE and high surface area carbons, the diffusion layer functioning as an electrolyte barrier, a conductive layer and a structural support; and

(c) an active layer, comprising at least a mixture of calcined perovskites and pyrolysed macrocycles, whereby the perovskites and the macrocycles are supported on high surface area carbons (preferably higher than in the diffusion layer),

displays a drastically improved performance. The electrode of the invention comprises both perovskites and pyrolysed porphyrins, combining the positive characteristics of these compounds, while avoiding the drawbacks of them used alone.

In one preferred embodiment, the perovskites are calcined by a temperature treatment of at least 500 ° C, and the macrocycles are pyrolysed by a temperature treatment of at least 400 ° C.

Furthermore, the invention refers to methods for preparing an electrode of the invention. Through the inventive preparation of the electrodes, higher surface areas (approx. 35 m²/g substance) are obtained than in normal preparations (7-8 m²/g). This is due to the fact that bigger agglomerates of the particles are not formed during the thermal heating and cooling process. Moreover, the invention discloses a fuel cell, or a metal-air battery, comprising the electrode of the invention.

The present invention describes methods, where reaction of carbon dioxide with the alkaline electrolyte during oxygen reduction is no longer the limiting step toward direct application of air as the reactant. Normally, when the catalysts are applied separately in the gas diffusion electrodes, the life span of the electrodes is limited to between 100 and 400 hours in the presence of carbon dioxide. In the present invention, the carbon dioxide, thanks to the new mixed types of catalysts, has not shown any influence on the activity or stability of the porous gas diffusion electrodes, especially at low and medium temperatures and at constant load of 100 mA/cm². The invention describes methods of electrocatalyst preparation and hence application in gas-diffusion or bifunctional air electrodes in alkaline electrolytes and reports electrochemical test results both in pure oxygen and air and at temperatures between 25 and 50° C. The invention can also display thousands of hours of electrochemical reduction if carbon dioxide purification is introduced and the temperature is increased to 70 or 80° C.

### DETAILED DESCRIPTION OF THE INVENTION

The compound class “perovskites” refers to compounds having the general formula ABO₃, wherein A and B are positive ions, and O is oxygen.

The compound class “pyrolyzed macrocycles” refers to among others porphyrin-compounds having undergone pyrolysis, as described below. Porphyrins are a group of pigment-molecules, naturally occurring in nature. They often form complexes with metals. Pyrolysed macrocycles in the context of the invention also refers to a phtalocyanine or a simple or complex N₄-compound.

The porous electrode prepared offers efficient performance at high current densities coupled with prolonged service life. The cathode, which is of the multi-layer gas diffusion electrode type, consists of current collector with mesh sizes of 0.025-0.06, the diffusion layer and the catalyzed layer. The diffusion layer, backing layer, gas supplying layer or wet-proofed layer consists of either a mixture of polytetrafluoroethylene (PTFE) dispersion (60% by weight) and a conductive support or of only high porosity PTFE. The carbon may be a high surface area highly porous and conductive furnace, thermal or channel black, or graphite, obtained commercially or thermally and/or chemically treated high surface area carbons. The PTFE and support are well blended in order to have an even distribution and a very homogeneous mixture. The catalyzed carbon contains active materials of the mixtures of perovskites and macrocycle black complexes. The term “macrocycle black complexes” is used herein for convenience, and means a mixture of a metal or metals and the macrocycle residue, which remains upon heating such complexes at temperatures above 300° C.

Low electrocatalyst loading requirements in the above mentioned types of electrodes imply lower cost in comparison with noble metal catalysts for large-scale power plant, traction or battery applications. Electrocatalysts of the mixed type containing both perovskites and macrocycles on high surface area conductive support were prepared according to this invention and incorporated into porous gas diffusion electrodes. The gas diffusion electrodes may be of the planar or cylindrical or any mode, prepared by such techniques as rolling the paste, tape-casting, silk screening, brushing, spraying of the electrode materials or high compaction of the powders of the active (catalyst) and diffusion layers. Electrodes consisting of metal screen current collector, the highly wet-proofed diffusion layer and the mixed catalysts applied on less wet-proofed conductive high surface area carbons as the active layer were manufactured and assembled in cells. Electrochemical test procedures and longevity studies of the oxygen gas diffusion electrodes were performed in order to substantiate the activity and stability of the electrodes, especially with air without any further removal of carbon dioxide.

The catalyst layer or active layer usually composes of a macrocycle with transition metals, such as Fe, Co, Ni, Cr, Mn, Cu, etc. The metal macrocyclic complexes or N4-metal compounds prepared by the wet incipient or impregnation method of porphyrins or phtalocyanines dispersed on high surface area carbons are subjected to pyrolysis at temperatures between 400 and 1000° C. The solvent used to dissolve the macrocycles may be an organic carboxylic acid, such as formic, acetic, propanoic or butanoic acids or inorganic acids, such as hydrochloric, hydrofluoric, or sulfuric acids. The nitrate, carbonate, sulfate, acetate or hydroxide compounds of the transition metals are also dissolved in a proper solvent of alcohols, such as ethanol, methanol, propanol or in deionized water. After blending of the carbon, drying and homogenization in a mixer, the thermal treatment is carried out in a protective atmosphere, for example nitrogen, argon or helium, and allowed to stay in the oven between 1 and 12 hours.

Although complexing of the metal-macrocycle compounds is possible by different refluxing solvents, it is a particular feature of this invention to use direct application of the metal salts or hydroxides on the carbon support. Mixing in blenders and ultrasonic agitation of the compounds both in the mixtures and solvents creates well-homogenized and dispersed catalyst particles on the carbon support. It is also preferable for the catalyzed carbon undergoing pyrolysis to cool down after the high temperature treatment to room temperature in the cooling zone of the oven with a constant flow of water. The macrocycle black with the transition metal on carbon has usually surface areas of 50-450 m²/g, average pore diameters of 50-100 angstroms and cumulative pore volume of 0.3-0.9 cm³/g of pores between 17 and 3000 angstrom in diameter.

The perovskite catalysts of the form ABO₃ (wherein A is at least one of the group IIA (Ba, Sr, Ca), IIIA (Y, Sc) and/or the lanthanides (La, Ce, Sm, Pr, Nd), and B is at least one or more of the transition metals (Co, Mn, Fe, Ni, Cu, Cr, Pd, Pt, Ru, Rh, Ir)) for supported dispersed electrocatalysts are prepared from their nitrates, citrates, oxides or carbonates by the spray pyrolysis, freeze drying or precipitation methods. The oxide compounds usually compose of metallic ion ratios of A as A1-xAx, where x varies between 0.1 and 0.9. The compounds after synthesis are washed with abundant deionized or distilled water to remove any un-reacted salts and are heat-treated at elevated temperatures within the range of 500 to about 1000° C. Such heating is performed in the presence of air or pure oxygen at prolonged hours, depending on the amount of the sample. Heat-treatment can also be carried out in the presence of high surface area carbons and by so doing the oxidation step is shortened, the temperature of calcination decreased and a product with higher surface area can be obtained. This step can be made possible either by co-precipitation of the salts on carbon or by blending the carbon to the dried precipitate. The catalysts are preferably cooled rapidly by placing the stainless steel crucible, alumina boat or any kind of holder in the cooling zone of the oven. The catalyst materials are then washed with diluted acids of acetic, formic or hydrochloric acids, normally 0.1 to 0.5 M to remove unreacted compounds and at the same time change the alkalinity and wettability of the perovskites.

The gas-diffusion layer consists of either a mixture of carbon and PTFE or of a backing layer of PTFE. Typically, the PTFE content in the carbon mixture will be about 30 to 70 weight percent with the rest being the conductive carbon. The high hydrophobicity of this layer is to serve as a structural support and allow penetration of the gas reactant to the active layer. A hydrocarbon solvent is introduced to the carbon-PTFE mixture in order to obtain a rollable paste, onto which the active layer is going to be double rolled. The backing layer consists of the PTFE dispersion (60% by weight) and salts of either ammonium bicarbonate or sodium chloride. The salts are leached out from the PTFE felt, which has been rolled into a specific thickness. By doing this step, the porosity of the backing layer is increased and lies between 40 and 60%. The backing layer is normally pressed into the current collector at high compressions (150-300 kg/cm²), before applying the active layer. The placement of the active layer can be varied and may be with the wire mesh current collector in between the active layer and the diffusion layer, or in the order of wire mesh current collector, active layer and diffusion layer, or active layer, diffusion layer and wire mesh current collector.

The active layer consists of a mixture of the perovskite and the pyrolyzed porphyrin. The metal porphyrin concentration before pyrolysis lies between 10-40 weight percent on the high surface area carbon. The total concentration of the catalysts containing perovskite with the metal porphyrin, carbon and PTFE in the active layer are in the range of 20-60%, 10-40% and 10-40% respectively. Where an active layer will be prepared from this resulting mixture, a blend of the catalysts plus a gas supplying material can be combined in proportions of at least 1-1.5 weight parts of the active material of 0.5-1.0 weight parts of the gas supplying material. Balance of the hydrophilic or hydrophobic nature of the active layer is important, in order to limit the flooding or drowning by the electrolyte or total penetration by gas to this layer. Typically, the concentration of perovskite and metal porphyrin in the catalytically active layer is in the range of 5-15 mg per square centimeter and 0.5-3 mg per square centimeter of the geometrical area of the electrode, respectively. Remarkably, when the catalysts are used separately or not blended in the right proportions, the electrode performance and stability is markedly influenced. The normal life-test of the electrodes with unpurified air for non-proportionally mixed catalysts or individual catalyst lies between 400 and 100 hours both at 25 and 50° C., respectively.

The diffusion layer is rolled on a nickel, gold, silver, copper, silver plated nickel, silver plated or nickel plated iron, etc. wire mesh (60 mesh) to a thickness of 0.7 mm. The electrode materials of the active layer are mixed in a mixer and a hydrocarbon solvent is added for better homogenisation and dispersion in a colloid mill. The mixture is filtrated and made into a rollable paste. The active layer is separately rolled into a thickness of 0.5 mm. The two layers are then double rolled into a total thickness of 1.0 mm. The whole electrode is then pressed at 100-300 kg/cm², depending on whether the diffusion layer is carbon-based or backing layer. The electrode is dried at moderate temperatures (40-60° C.) and sintered at 300-320° C. for about an hour in a protective atmosphere of nitrogen. The total thickness of the electrode after these procedures is found to be between 900 and 500 microns, with the combined collector and diffusion layer lying in the range of 800-400 microns and the active layer in the range of 500-100 microns. Alternatively, the active layer can also be pressed to the diffusion layer in a mixed powder form of the electrode materials or direct application of the mixed catalyst materials supported on high surface area carbons on polymer materials with or without binders.

For the most efficient operation of the present invention, the catalysts used for application in the alkaline electrolyte, both in pure oxygen and air, preferably contain CoTPP (cobalt tetraphenyl porphyrin) charred residue on carbon and La0.1Ca0.9MnO3. These cheap catalyst combinations have shown high performances and have been operated without or with little decay rate in pure oxygen, scrubbed air and air for more than two thousand hours both at 50° C. and 25° C., respectively.

Also, in one embodiment the invention refers to an oxygen reduction electrode for use as a cathode in aqueous alkaline and carbonate electrolytes and solid polymeric membranes.

In another preferred embodiment, the invention refers to the use of the oxygen reduction electrode as described above in a fuel cell, a metal-air battery or the like, wherein the gas incoming to the electrode comprises more than 0.03% (vol/vol) CO₂. The electrode invention may of course also be used with air, which is free from CO₂, or pure oxygen, but to use it with gas comprising CO₂ is a specific property of the invention.

In another aspect, a fuel cell, or an air-metal battery, is a part of the invention. In addition to the oxygen reduction electrode of the invention, the construction of these may be performed in any conventional way, as long as the characteristics described here are provided for.

A fuel cell according to the invention comprises an oxygen reduction electrode as described above functioning as a cathode, and an anode for hydrogen oxidation, which anode is used in combination with either mobile or immobile electrolytes, such as acidic, alkaline or salts, embedded in a porous matrix, such as polymers, asbestos, papers, graphites, whereby the electrochemical reaction leads to the generation of electricity, heat and water. Thus, these electrochemical devices, which are not limited by the Carnot cycle as combustion engines, have higher electric efficiencies, are environmentally benign and noiseless, are independent on plant sizes for installations and are directly applicable to light-and heavy-duty propulsion, extraterrestrial (space and aquatic) systems and portable electric power sources.

A metal-air battery according to the invention comprises an oxygen reduction electrode as described above functioning as a discharge electrode, and an anode, which is made up of one or more of zinc, aluminium, iron, metal-hydrides, whereby the anode (the negative electrode) after having been fully discharged is electrically charged against a third electrode of nickel or alloys of nickel or by gas charging. By so doing a lightweight construction of the air electrode instead of the heavy electrodes of nickel is easily replaced, while at the same time oxidation or disintegration or corrosion of the carbon with the active catalyst combinations is avoided and higher energy density is achieved for requirements in small and high power facilities.

The following examples aim to illustrate the invention by way of examples, and are not intended to limit the scope of the invention in any way.

### EXAMPLES

### Example 1

The La0.1Ca0.9MnO3 was prepared from the nitrate salts of respective elements. This perovskite was prepared by direct precipitation and prepared accordingly by thermal treatment at 700° C. and cooled immediately in a water-cooling zone of the quartz tube furnace. This method of preparation gives a higher surface area, usually in the range 25-60 m²/g than other methods of perovskite preparation. The CoTPP on high surface area carbons (mixtures of Ketjen black EC and Vulcan XC-72) together with the perovskite is blended with PTFE and additional Vulcan XC-72 in a mixer. A hydrocarbon solvent is added and the electrode material is milled and homogenized in a colloid mill and then filtered off to obtain a paste to be rolled on the diffusion layer. The diffusion layer consists of 40% carbon (Vulcan XC-72) and 60% PTFE.

The perovskite content was 9.5 mg, while the CoTPP loading was 1.5 mg per square centimeter of the geometrical electrode surface area. The following tables (I-IV) show the performance and stability of the gas diffusion electrodes, operating at 25 and 50° C., respectively, with a flow of air and pure oxygen and in 6M KOH. The potential readings are reported versus Hg/HgO reference electrodes. Table 1 shows the initial performance of the gas diffusion electrode, while Table 2 shows the stability of the same after 2365 hours at a constant load of 100 mA/cm².

TABLE I
Initial and after 2500 hours of performance,
operating with air and at 25° C.

| i (mA/cm²) | E (mV) | E (mV) |
|---|---|---|
| 0 | 36 | 32 |
| 10 | −28 | −31 |
| 25 | −54 | −54 |
| 50 | −81 | −83 |
| 100 | −116 | −124 |
| 150 | −143 | −163 |
| 200 | −173 | −203 |
| 250 | −207 | −248 |
| 300 | −249 | −293 |

TABLE II
Performance at 50° C., with air both
initially and after 800 operating hours.

| i (mA/cm2) | E (mV) | E (mV) |
|---|---|---|
| 0 | 45 | 39 |
| 10 | −16 | −35 |
| 25 | −41 | −59 |
| 50 | −65 | −84 |
| 100 | −93 | −129 |
| 150 | −114 | −189 |
| 200 | −132 | −235 |
| 250 | −158 | −289 |
| 300 | −190 | −343 |

TABLE III
Initial performance at 25° C. and
pure oxygen and after 1500 hours.

| i (mA/cm²) | E (mV) | E (mV) |
|---|---|---|
| 0 | 57 | 52 |
| 10 | −9 | −2 |
| 25 | −30 | −20 |
| 50 | −48 | −39 |
| 100 | −73 | −67 |
| 150 | −92 | −88 |
| 200 | −107 | −105 |
| 250 | −118 | −117 |
| 300 | −130 | −131 |

TABLE IV
Initial performance at 50° C., with pure
oxygen and after 1300 of operating hours.

| i (mA/cm²) | E (mV) | E (mV) |
|---|---|---|
| 0 | 74 | 64 |
| 10 | 12 | −2 |
| 25 | −9 | −24 |
| 50 | −29 | −48 |
| 100 | −59 | −84 |
| 150 | −80 | −115 |
| 200 | −97 | −144 |
| 250 | −109 | −171 |
| 300 | −124 | −193 |

### Example 2

The fabrication method of the gas diffusion electrode is the same as in Example 1, with the only difference that the perovskite was prepared by the drop pyrolysis method, wherein mixtures of the compounds in the form of citrates or nitrates are dripped into a hot crucible at temperatures of 600-900° C. Although the perovskite prepared by this method has, higher average pore diameter (89.3 Å), lower pore volume (0.0207 cm³/g) and less than five times the surface area (6.22 m²/g ) of the perovskite indicated in Example 1, this gas diffusion electrode has also shown high performance and stability in the alkaline electrolyte for the reduction of oxygen. The following examples (V-VIII) show the performance and stability conditions of this type of electrodes both at 25 and 50° C., with air and pure oxygen and at a constant load of 100 mA/cm².

TABLE V
Initial and after 2000 hours performance at 25° C. and air.

| i (mA/cm²) | E (mV) | E (mV) |
|---|---|---|
| 0 | 58 | 53 |
| 10 | −25 | −46 |
| 25 | −51 | −72 |
| 50 | −78 | −106 |
| 100 | −112 | −148 |
| 150 | −142 | −191 |
| 200 | −175 | −234 |
| 250 | −215 | −282 |
| 300 | −246 | −336 |

TABLE VI
Initial performance and after 700 hours at 50° C. and air.

| i (mA/cm²) | E (mV) | E (mV) |
|---|---|---|
| 0 | 67 | 61 |
| 10 | −28 | −46 |
| 25 | −50 | −72 |
| 50 | −70 | −106 |
| 100 | −100 | −175 |
| 150 | −126 | −206 |
| 200 | −152 | −263 |
| 250 | −180 | −308 |
| 300 | −210 | −372 |

TABLE VII
Initial and after 1200 hours performance
at 25° C. and with pure oxygen.

| i (mA/cm²) | E (mV) | E (mV) |
|---|---|---|
| 0 | 72 | 62 |
| 10 | −6 | −12 |
| 25 | −25 | −29 |
| 50 | −43 | −51 |
| 100 | −72 | −78 |
| 150 | −96 | −99 |
| 200 | −113 | −118 |
| 250 | −132 | −135 |
| 300 | −149 | −149 |

TABLE VIII
Performance with pure oxygen and at 50 oC,
both initially and after 1200 hours.

| i (mA/cm2) | E (mV) | E (mV) |
|---|---|---|
| 0 | 78 | 66 |
| 10 | 3 | −10 |
| 25 | −13 | −33 |
| 50 | −30 | −52 |
| 100 | −53 | −77 |
| 150 | −69 | −96 |
| 200 | −82 | −111 |
| 250 | −94 | −127 |
| 300 | −104 | −141 |

### Example 3

The gas diffusion electrode in Example 1 has been tested for long-time operation in a half-cell configuration under a constant potential of −200 mV vs. Hg/HgO. The temperature was kept at 70° C. and the incoming air-stream was scrubbed in a soda lime bed for direct adsorption of carbon dioxide or removal of it from direct contact with the electrolyte. High stability and activity are thus, shown for higher temperature ranges thanks to the special the catalytic properties of the materials and electrode construction for oxygen reduction. The variation of the current density with time is given in Table IX.

TABLE IX
Longevity test of an electrode at 70° C. and with scrubbed air.

| i(mA/cm²) | time(hours) |
|---|---|
| 150 | 5 |
| 215 | 250 |
| 230 | 500 |
| 230 | 1000 |
| 215 | 1250 |
| 210 | 1500 |
| 260 | 2000 |
| 245 | 2250 |
| 195 | 2500 |
| 215 | 3000 |
| 170 | 3250 |

1. Porous oxygen reduction electrode for alkaline electrolytes comprising at least three layers:
(a) a supportive and conductive current collector;
(b) a diffusion layer, comprising at least PTFE and high surface area carbons, the diffusion layer functioning as an electrolyte barrier, a conductive layer and a structural support;
(c) an active layer, comprising at least a mixture of calcined perovskites and pyrolysed macrocycles, whereby the perovskites and the macrocycles are supported on high surface area carbons.

2. Oxygen reduction electrode according to claim 1, wherein the current collector has a mesh size in the interval of 0.025-0.6 mm.

3. Oxygen reduction electrode according to claim 1, wherein the diffusion layer has a thickness of less than 700 μm.

4. Oxygen reduction electrode according to claim 1 or 3, wherein the diffusion layer further comprises a conductive carbon support, which carbon support comprises furnace black, thermal black, channel black or graphite.

5. Oxygen reduction electrode according to claim 1, wherein the active layer has a thickness of less than 300 μm.

6. Oxygen reduction electrode according to claim 1 or 5, wherein the pyrolysed macrocycle is a porphyrin, a phtalocyanine or a simple or complex N₄-compound.

7. Oxygen reduction electrode according to claim 1 or 5-6, wherein the pyrolysed macrocycles of the active layer comprises transition metals, such as Fe, Co, Ni, Cr, Mn and Cu.

8. Oxygen reduction electrode according to any one of claim 1 or 5-7, wherein the pyrolysed macrocycles has a surface area of 50-450 m²/g, an average pore diameter of 50-100 Å, and a cumulative pore volume of 0.3-0.9 cm³/g of pores having a diameter from 17 to 3000 Å.

9. Oxygen reduction electrode according to claim 1 or 5, wherein the perovskites is of the form AₓB_{y}O₃, wherein A is at least one of the group IIA (Ba, Sr, Ca), IIIA (Y, Sc) and/or the lanthanides (La, Ce, Sm, Pr, Nd), and B is at least one or more of the transition metals (Co, Mn, Fe, Ni, Cu, Cr, Pd, Pt, Ru, Rh, Ir), and wherein x may vary between 0.1-0.9 and y may vary between 0.1-0.9.

10. Oxygen reduction electrode according to any one of claim 1 or 5-9, wherein the concentration of the pyrolyzed macrocycles and the perovskites in the active layer is in the interval of 5-15 mg/cm² and 0.5-3 mg/cm², respectively.

11. Oxygen reduction electrode according to any one of claim 1 or 5-10, wherein the active layer comprises perovskites and pyrolyzed macrocycles to a concentration of 20-60%, and further comprises carbon and PTFE to a concentration of 10-40% and 10-40%, respectively.

12. Oxygen reduction electrode according to any one of claim 1 or 5-11, whereby the pyrolyzed macrocycle compound is CoTPP (cobalt-tetraphenyl-porphyrin) and the perovskite is La0.1Ca0.9MnO3.

13. Oxygen reduction electrode according to any one of the preceding claims, for use as a cathode in aqueous alkaline and carbonate electrolytes and solid polymeric membranes.

14. Use of the oxygen reduction electrode of any one of claim 1-13 in a fuel cell or a metal-air battery, wherein the gas incoming to the electrode comprises more than 0.03% (vol/vol) CO₂.

15. Method for preparing an oxygen reduction electrode according to any one of claims 1-13, comprising the steps of:
(a) providing a current collector;
(b) providing a mixture of PTFE and carbon;
(c) adding a hydrocarbon solvent to the mixture of step (b), in order to obtain a rollable paste;
(d) providing a mixture of at least perovskites and pyrolyzed macrocycles;
(e) adding a hydrocarbon solvent to the mixture of step (d), in order to obtain a rollable paste;
(f) rolling the mixtures of step (c) and (e) separately;
(g) applying the rolled mixtures of step (f) to the current collector;
(h) pressing the construction of step (g) to an electrode.

16. Method according to claim 15, whereby the perovskites are prepared by the following steps:
(a) providing the perovskite compunds in mixture with a carbon support compound;
(b) washing with water;
(c) heat-treating at 500-1000° C.;
(d) rapid cooling to room temperature; and
(e) washing with diluted acid.

17. Method according to claim 15, whereby the pyrolyzed macrocycles are prepared by the following steps:
(a) providing the macrocycle compounds in mixture with a solvent;
(b) providing metal salts in mixture with a solvent;
(c) mixing the solutions of step (a) and (b);
(d) adding carbon;
(e) drying the mixture of step (d);
(f) homogenising the product of step (e);
(g) thermally treating the product of step (f) for 1-12 hours; and
(h) cooling to room temperature.

18. Fuel cell comprising an oxygen reduction electrode according to any one of claims 1-13 functioning as a cathode, and an anode for hydrogen oxidation, which anode is used in combination with either mobile or immobile electrolytes, which are embedded in a porous matrix or membrane assembly.

19. Metal-air battery comprising an oxygen reduction electrode according to any one of the claims 1-13 functioning as a discharge electrode, and an anode or negative electrode, which is made up of one or more of zinc, aluminium, iron, metal-hydrides.
